(19) United States
(12) Patent Application Publication
(10) Pub. No.: US 2026/0302485 A1
(43) Pub. Date: Oct. 1, 2026

(54) HOLDING STRUCTURE, BATTERY MODULE, AND MACHINE BODY

(71) Applicant: HONDA MOTOR CO., LTD., Tokyo (JP)

(72) Inventors: Daisuke NOHARA, Saitama (JP); Masaki GOTO, Saitama (JP)

(21) Appl. No.: 19/459,252

(22) Filed: Jan. 26, 2026

(30) Foreign Application Priority Data
Mar. 31, 2025 (JP) 2025-059620

(51) Int. Cl. H01M 50/249; B60L 53/80; H01M 50/258; H01M 50/296

(52) U.S. Cl. CPC H01M 50/249; B60L 53/80; H01M 50/258; H01M 50/296; H01M 2220/20

(57) ABSTRACT

A holding structure for detachably holding a battery module on a machine body includes: a shaft provided on a lower portion of the battery module; and a receiving recess provided in the machine body and opening in a tilt direction which is tilted outward and upward, wherein the shaft is rotatably received in the receiving recess such that the battery module is displaceable between a use position and a removal position where the battery module is tilted in a direction in which an upper portion is separated away from the machine body and where the battery module can be removed along the tilt direction, the battery module includes an engagement part provided above the shaft, and the machine body is provided with a support part supporting a side surface of the engagement part on a side opposite from the machine body when the battery module is in the removal position.

### TECHNICAL FIELD

The present invention relates to a holding structure for holding a battery module on a machine body such as a mobile body or a robot, a battery module constituting the holding structure, and a machine body.

### BACKGROUND ART

In recent years, there has been an increase in efforts to realize a low-carbon society or a carbon-neutral society. In relation to various mobile bodies (including vehicles), robots, or the like, various research and development on electrification technology are being conducted to reduce CO2 emission and to improve energy efficiency.

To electrify a mobile body or a robot, it is necessary to install a battery in a machine body constituting the mobile body or the robot. Considering workability during replacement, it is preferred that such a battery can be mounted to the machine body easily.

JP2008-84744A discloses a housing and a battery module mounted to the housing. The battery module includes a battery and a flat plate-shaped base plate for supporting the battery, and the housing is provided with an opening in which the base plate is fitted. By hooking one end of the base plate onto an opening edge of the opening and rotating the base plate about the opening edge as a rotation center, the base plate is fitted into the opening of the housing. Thereby, the battery module is mounted to the housing.

In a mobile body, a robot, or the like, the battery module may be mounted to the machine body by hooking the battery module onto a part of the machine body and rotating the battery module, as described in JP2008-84744A. However, when the battery is hooked onto a part of the machine body, a load from the battery may be concentrated on the part of the machine body.

### SUMMARY OF THE INVENTION

In view of the foregoing background, an object of the present invention is to provide a holding structure, a battery module, and a machine body capable of dispersing the load that may be applied from the battery module to the machine body during installation, and thereby to contribute to energy efficiency.

To achieve the above object, one aspect of the present invention provides a holding structure for detachably holding a battery module on a machine body, the holding structure comprising: at least one shaft provided on a lower portion of the battery module; and at least one receiving recess provided in the machine body and opening in a tilt direction which is tilted outward of the machine body toward an upper side, wherein each of the at least one shaft is rotatably received in a corresponding one of the at least one receiving recess such that the battery module is displaceable between a use position and a removal position where, compared to the use position, the battery module is tilted in a direction in which an upper portion thereof is separated away from the machine body and where the battery module can be removed along the tilt direction, the battery module includes at least one engagement part provided above the at least one shaft, and the machine body is provided with at least one support part that supports a side surface of the at least one engagement part on a side opposite from the machine body when the battery module is in the removal position.

To achieve the above object, another aspect of the present invention provides a battery module configured to be supported on machine body to be displaceable between a use position and a removal position where, compared to the use position, the battery module is tilted in a direction in which an upper portion thereof is separated away from the machine body and where the battery module can be removed, the battery module comprising: a main body; a shaft provided on a lower portion of the main body to be rotatably supported by the machine body; and an engagement part provided above the shaft of the main body and supported on the machine body in the removal position.

To achieve the above object, another aspect of the present invention provides a machine body configured to support a battery module to be displaceable between a use position and a removal position where, compared to the use position, the battery module is tilted in a direction in which an upper portion thereof is separated away from the machine body and where the battery module can be removed, by rotatably supporting a shaft of the battery module, wherein the machine body is provided with a support part that supports the battery module when the battery module is in the removal position.

According to the above aspects, a holding structure, a battery module, and a machine body capable of dispersing the load that may be applied from the battery module to the machine body during installation can be provided.

### BRIEF DESCRIPTION OF THE DRAWINGS

FIG. 1 is a side view of an electric vehicle in which a holding structure is provided;

FIG. 2 is a side view of the electric vehicle with an outer shell being removed to schematically show an internal structure of the electric vehicle;

FIG. 3 is a rear view of the electric vehicle;

FIG. 4 is a perspective view of a battery module and a machine body in a use position;

FIG. 5 is a side view of the battery module and the machine body in the use position;

FIG. 6 is a front view of the battery module;

FIG. 7 is an exploded perspective view of a mounting member;

FIG. 8 is a perspective view of the battery module and the machine body in an insertion position; and

FIG. 9 is a side view of the battery module and the machine body in the insertion position.

### DETAILED DESCRIPTION OF THE INVENTION

In the following, an embodiment of a holding structure, a battery module, and a machine body according to the present invention will be described with reference to the drawings.

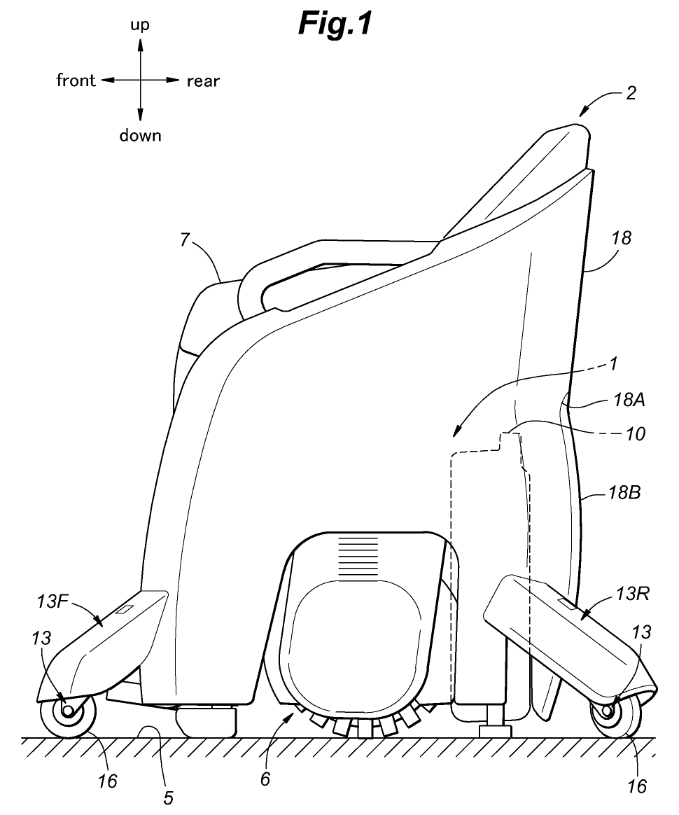

A holding structure 1 is a structure for detachably holding a battery on a machine body of an electric mobile body, a robot, or the like. Here, description will be made of an example in which the holding structure 1 is provided on a single-seater electric vehicle 2 shown in FIG. 1.

Note that in the following description, front, rear, left, right, up, and down directions are defined based on the front-rear direction of the electric vehicle 2 for convenience of explanation. However, this description of directions is only for convenience of explanation, and the present invention is not limited to this description of directions. Also, in the following, when not particularly mentioned, description will be made based on a state in which the battery is fixedly mounted to the machine body.

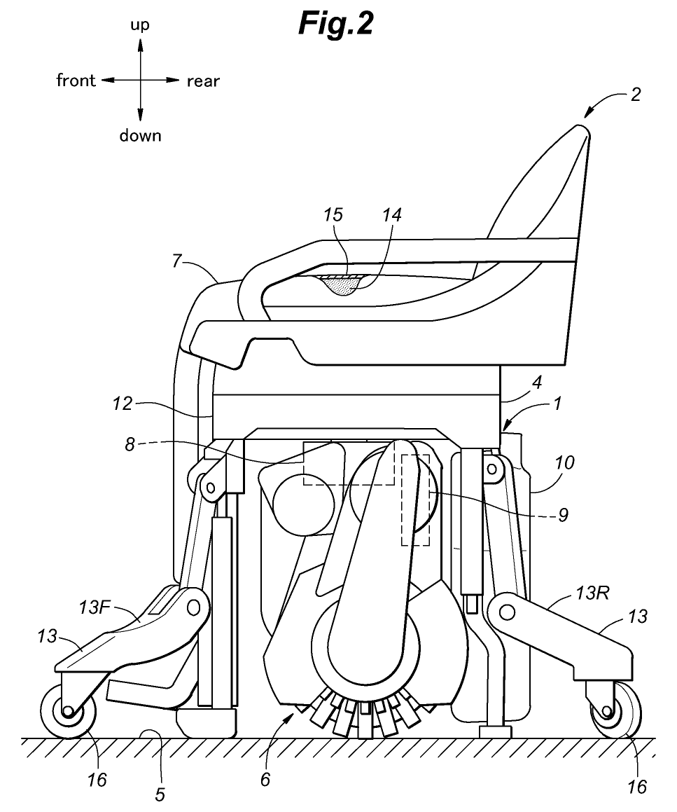

As shown in FIG. 2, the electric vehicle 2 is a so-called inverted pendulum vehicle and includes a vehicle body frame 4 (one example of the machine body), at least one drive unit 6 provided on the vehicle body frame 4 and movable on a floor surface 5, a seat 7 disposed above the vehicle body frame 4 to support the buttocks of the user, a lift device 8 provided between the vehicle body frame 4 and the seat 7, and a control device 9 that controls the drive unit 6 and the lift device 8.

A battery module 10 is mounted to the vehicle body frame 4 via the holding structure 1. The battery module 10 includes a battery (not shown in the drawings), and the electric vehicle 2 travels using the electric power supplied from the battery.

The seat 7 includes a frame part 12 having a quadrilateral shape in top view, leg parts 13 extending downward from the frame part 12, a pad member 14 supported on the frame part 12, and a skin material 15 covering the outer surface of the pad member 14. The lower end of each leg part 13 is provided with a roller 16 for allowing the electric vehicle 2 to travel.

The control device 9 is configured by a microcomputer provided with a processor and a memory. The control device 9 drives the lift device 8 to raise the leg parts 13 as appropriate, and causes the electric vehicle 2 to travel with the drive unit 6 in a state in which the leg parts 13 are separated from the floor surface 5. Also, the control device 9 drives the lift device 8 to cause the leg parts 13 to contact the floor surface 5, and causes the electric vehicle 2 to travel with the drive unit 6 in a state in which the leg parts 13 are in contact with the floor surface 5.

In the present embodiment, the seat 7 includes, as the leg parts 13, a pair of left and right front leg parts 13F positioned on the front side and a pair of left and right rear leg parts 13R positioned on the rear side, and each of the front leg parts 13F and the rear leg parts 13R is coupled to a corner part of the frame part 12. The battery module 10 is mounted to the vehicle body frame 4 at a position between the left rear leg part 13R and the right rear leg part 13R as viewed from the rear.

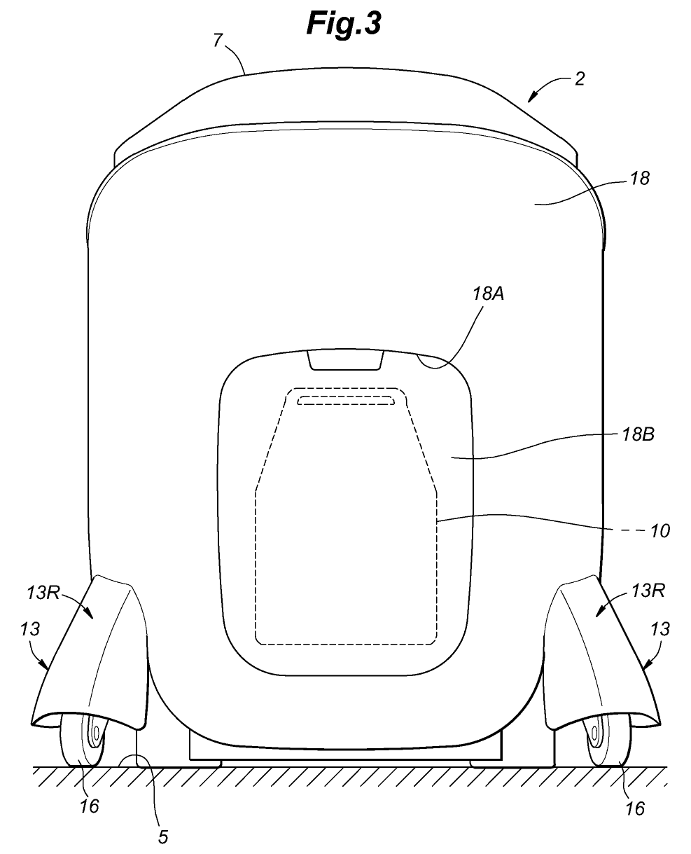

As shown in FIGS. 1 and 3, the electric vehicle 2 is provided with an outer shell 18 for covering the drive unit 6. As shown in FIG. 3, the outer shell 18 is provided with an opening 18A through which the battery module 10 is taken out and a lid body 18B for closing the opening 18A.

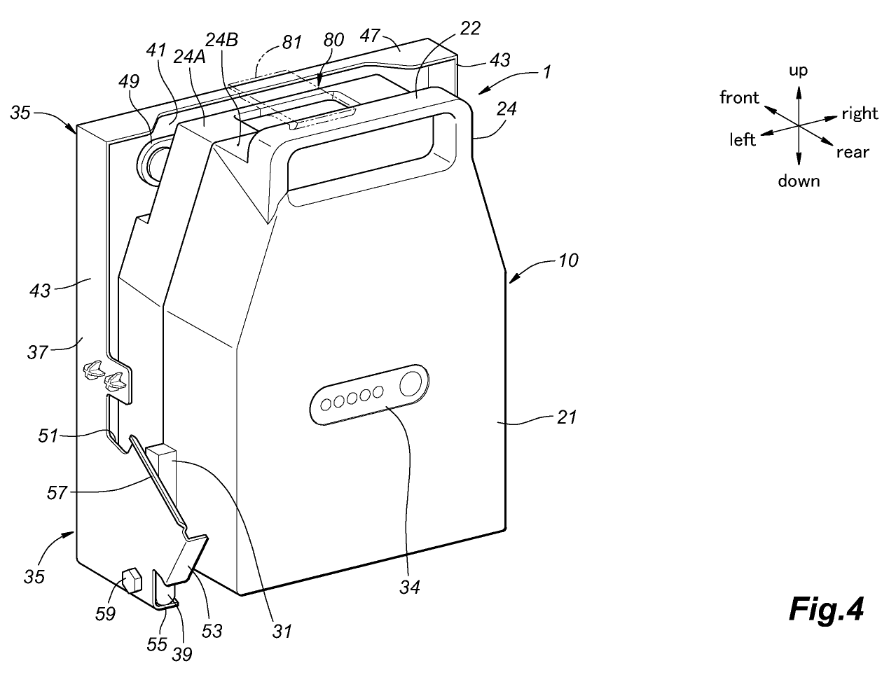

As shown in FIG. 4, the battery module 10 includes a module main body 21 in a box shape having a substantially trapezoidal shape as viewed from the front and a grip 22 provided on a rear portion of an upper surface of the module main body 21. Inside the module main body 21, a battery is accommodated.

In the present embodiment, the battery module 10 includes a battery and a case 24 made of resin. The case 24 includes a case front part 24A constituting a front half thereof and a case rear part 24B constituting a rear half thereof, and the case front part 24A and the case rear part 24B are joined to define a containment chamber (not shown in the drawings) for accommodating the battery.

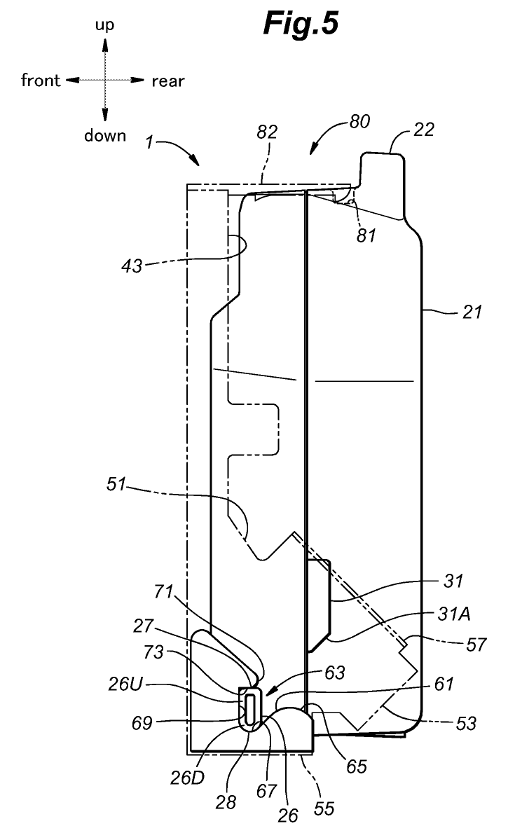

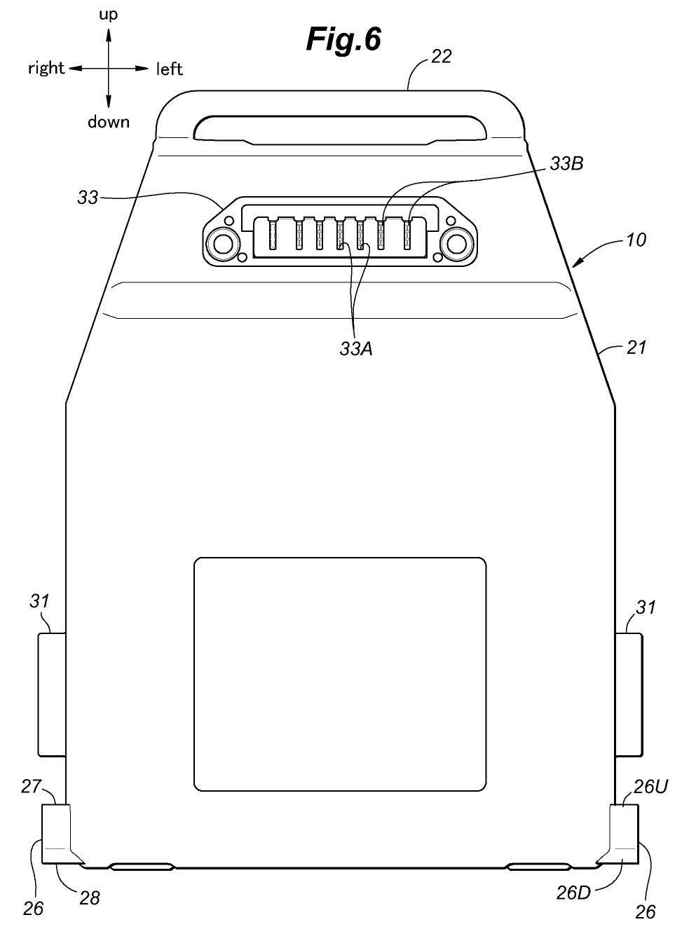

The module main body 21 is provided with at least one shaft 26. In the present embodiment, as shown in FIGS. 5, 6, and 7, the module main body 21 is provided with a pair of left and right shafts 26. The shafts 26 are respectively provided on lower portions of the left and right side surfaces of the module main body 21 (namely, a lower portion of the battery module 10). The shafts 26 each have a columnar shape protruding laterally outward from the left or right side surface of the module main body 21. As shown in FIG. 6, the left shaft 26 and the right shaft 26 are bilaterally symmetric with respect to a symmetry plane that passes the center of the module main body 21 and extends in the vertical direction.

As shown in FIG. 5, each shaft 26 includes a shaft upper portion 26U constituting an upper portion thereof and a shaft lower portion 26D constituting a lower portion thereof. The shaft upper portion 26U has a rectangular cross section elongated in the up-down direction and has a rectangular pillar shape. The shaft lower portion 26D has a pillar shape having a cross section in a shape of a longitudinally halved ellipse. The shaft lower portion 26D is joined to the lower edge of the shaft upper portion 26U. A lower edge of the shaft 26 is provided with a shaft-side curved surface 28 which has a convex shape protruding downward and is curved gently. An upper surface of the shaft upper portion 26U is provided with a shaft-side flat surface 27 which is flat.

The module main body 21 is provided with at least one engagement part 31. In the present embodiment, as shown in FIGS. 5, 6, and 7, the module main body 21 is provided with a pair of left and right engagement parts 31. The engagement parts 31 protrude laterally outward from the left and right side surfaces of the module main body 21, respectively. As shown in FIG. 6, the left engagement part 31 and the right engagement part 31 are bilaterally symmetric with respect to a symmetry plane that passes the center of the module main body 21 and extends in the vertical direction.

The engagement parts 31 are positioned above the shafts 26, respectively. In the present embodiment, as shown in FIG. 5, each engagement part 31 is positioned at approximately the center of the module main body 21 in the front-rear direction.

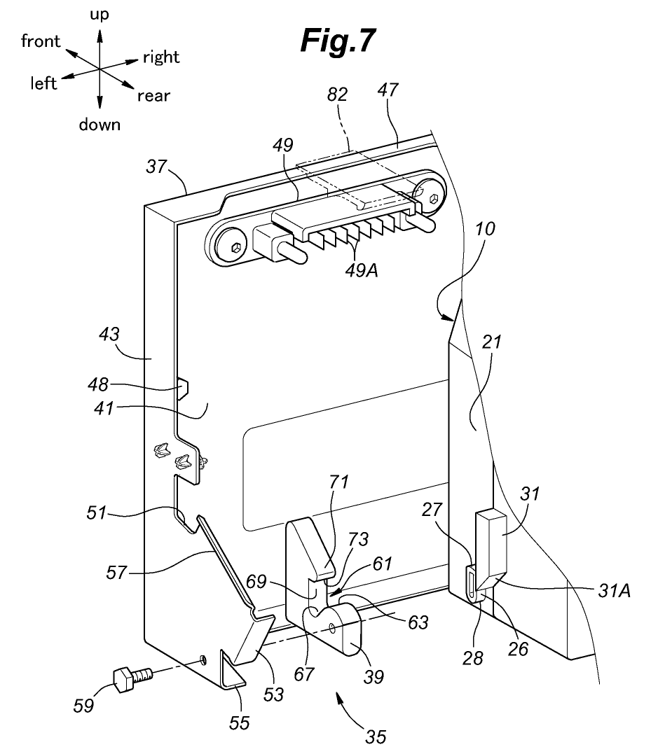

As shown in FIG. 7, each engagement part 31 has a columnar shape protruding in the left-right direction. As shown in FIG. 5, the cross section of the engagement part 31 taken along a plane extending vertically and in the front-rear direction has a trapezoidal shape formed by obliquely cutting a rear lower part of a rectangle elongated in the up-down direction. The width of the engagement part 31 in the up-down direction is greater than the width of the same in the front-rear direction, and the engagement part 31 is elongated in the up-down direction. At the lower edge of the rear surface of the engagement part 31, an inclined surface 31A that is inclined downward toward the front is formed.

As shown in FIG. 6, at least one power feeding connector 33 is provided on an upper portion of the front surface of the module main body 21. The power feeding connector 33 is a connector for feeding power from the battery to devices such as the drive unit 6, the lift device 8, and the control device 9. In the present embodiment, the power feeding connector 33 is a female connector and is provided with multiple terminal chambers 33A that open forward. Inside the terminal chambers 33A, female terminals 33B made of metal are provided.

The power feeding connector 33 is positioned above the shafts 26. In the present embodiment, the power feeding connector 33 is positioned higher than the engagement parts 31.

Besides, as shown in FIG. 4, the module main body 21 may be provided with a display unit 34 (may be also called an indicator) for displaying the state of the battery. The display unit 34 may be composed of one or more light emitting elements (such as light emission diodes). The display unit 34 may display the state of charge of the battery or may display whether the battery is normal.

As shown in FIGS. 4 and 5, the electric vehicle 2 is provided with a mounting member 35 for mounting the battery module 10 on the vehicle body frame 4. The mounting member 35 includes a plate 37 formed by bending a sheet metal member and a pair of left and right blocks 39 joined to the plate 37.

As shown in FIG. 4, the plate 37 includes a main portion 41 which is rectangular in shape and has surfaces facing in the front-rear direction and a pair of left and right side wall portions 43 extending out rearward from the left and right edges of the main portion 41. As shown in FIG. 7, bolt holes are provided at appropriate positions of the main portion 41, and the plate 37 may be fastened and fixed to the vehicle body frame 4 with bolts 48 passing through the bolt holes. Besides, as shown in FIG. 1, the plate 37 may be provided with an upper wall portion 47 that extends rearward from the upper edge of the main portion 41.

As shown in FIG. 7, a power receiving connector 49 is provided on an upper portion of the rear surface of the main portion 41. The power receiving connector 49 is a connector to be connected to the power feeding connector 33 to receive power from the battery module 10. In the present embodiment, the power receiving connector 49 is a male connector and is provided with multiple male terminals 49A. The male terminal 49A are each composed of a plate member made of metal, and when inserted into the corresponding terminal chambers 33A, the male terminals 49A conductively contact the female terminals 33B provided in the terminal chambers 33A.

Each of the side wall portions 43 has a flat plate shape having surfaces facing in the left-right direction. Lower portions of the left and right side wall portions 43 are respectively provided with extension parts 51 that extend rearward. Each of the extension parts 51 has a flat plate shape having surfaces facing in the left-right direction. Each of the rear edges of the extension parts 51 is inclined downward toward the front. The rear edges of the extension parts 51 are respectively provided with support parts 53 that extend toward each other.

Each support part 53 has a flat plate shape inclined downward toward the front. The length of the upper surface of the support part 53 is preferably longer than the length of the rear surface of the engagement part 31 in the up-down direction.

Lower edges of the extension parts 51 are respectively provided with lower edge parts 55 that extend toward each other. Each of the lower edge parts 55 has a flat plate shape having surfaces facing in the up-down direction. Each of the lower edge parts 55 is positioned below the corresponding support part 53.

Upper edges of the extension parts 51 are respectively provided with flat plate-shaped diverging parts 57 extending away from each other while curving.

As shown in FIG. 7, each of the blocks 39 has a thick plate shape with surfaces facing in the left-right direction. In side view, each block 39 has a trapezoidal shape formed by cutting off a triangular upper rear portion of a rectangle elongated in the up-down direction. Each block 39 is preferably composed of a member made of metal.

Each block 39 is provided with a screw hole extending in the left-right direction, and each side wall portion 43 is provided with a through hole at a position corresponding to the screw hole. The block 39 is fastened to the laterally inner side surface of the plate 37 by a bolt 59 that passes through the through hole and is engaged with the screw hole. Thereby, the block 39 is fixed to the vehicle body frame 4 via the plate 37. Preferably, as shown in FIG. 1, the lower edge of the block 39 contacts the upper surface of the lower edge part 55 and the block 39 is supported by the lower edge part 55 from below.

As shown in FIGS. 5 and 7, the block 39 is provided with a receiving recess 61 for receiving the shaft 26. The receiving recess 61 is a recess provided in the upper edge the rear portion of the block 39 and extends in a direction that is inclined downward toward the front (toward the vehicle body frame 4). The receiving recess 61 opens in a tilt direction D that is tilted in a direction away from the vehicle body frame 4 (namely, outward of the machine body) toward an upper side.

The upper end of the receiving recess 61 is provided with an opening 63 through which the shaft 26 can be inserted. As shown in FIG. 5, a part defining the lower edge of the opening 63 is chamfered. Thereby, at the lower edge of the opening of the receiving recess 61, a machine body-side curved surface 65 that is curved to be convex upward is formed.

The bottom surface (lower surface) of the receiving recess 61 is formed with a recess-side curved surface 67 that is curved to be convex downward. The radius (R) of the inscribed circle of the recess-side curved surface 67 may be greater than the radius (R) of the shaft-side curved surface 28. Thereby, rotation (rolling) of the shaft 26 is favorably performed in the receiving recess 61.

Note that in the present embodiment, a lower half of the upper edge of the receiving recess 61 is cut off along the rolling trajectory of the shaft 26 so as not to hinder the rolling of the shaft 26. Thereby, the lower half of the upper edge of the receiving recess 61 is formed with an extended part 69 that is recessed toward the front.

An upper half of the upper edge of the receiving recess 61 is provided with a restricting part 71 that protrudes toward the rear. As shown in FIG. 2, the restricting part 71 is preferably formed by cutting off the lower half of the upper edge of the receiving recess 61 (namely, by providing the extended part 69). As shown in FIG. 5, when the battery module 10 is in the use position, the restricting part 71 opposes the shaft 26 (specifically, the shaft upper portion 26U) and restricts an upward movement of the shaft 26.

The lower surface of the restricting part 71 is preferably provided with a restriction surface 73 that faces downward and is substantially horizontal. Thereby, when the battery module 10 is in the use position, the upper surface of the shaft upper portion 26U is disposed to be substantially horizontal. As a result, the restriction surface 73 and the upper surface (the shaft-side flat surface 27) of the shaft 26 face each other, whereby an upward movement of the shaft 26 can be restricted more reliably. Note that when the battery module 10 is in the use position, the shaft 26 preferably contacts the recess-side curved surface 67 and the restriction surface 73 to be sandwiched by the recess-side curved surface 67 and the restriction surface 73. Thereby, the movement of the shaft 26 in the up-down direction can be restricted more reliably.

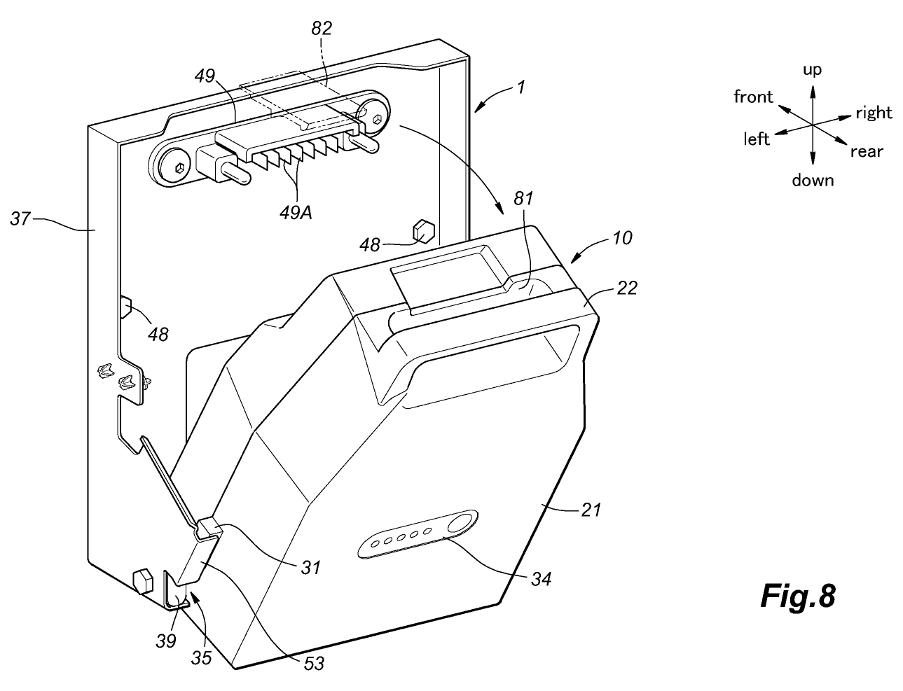

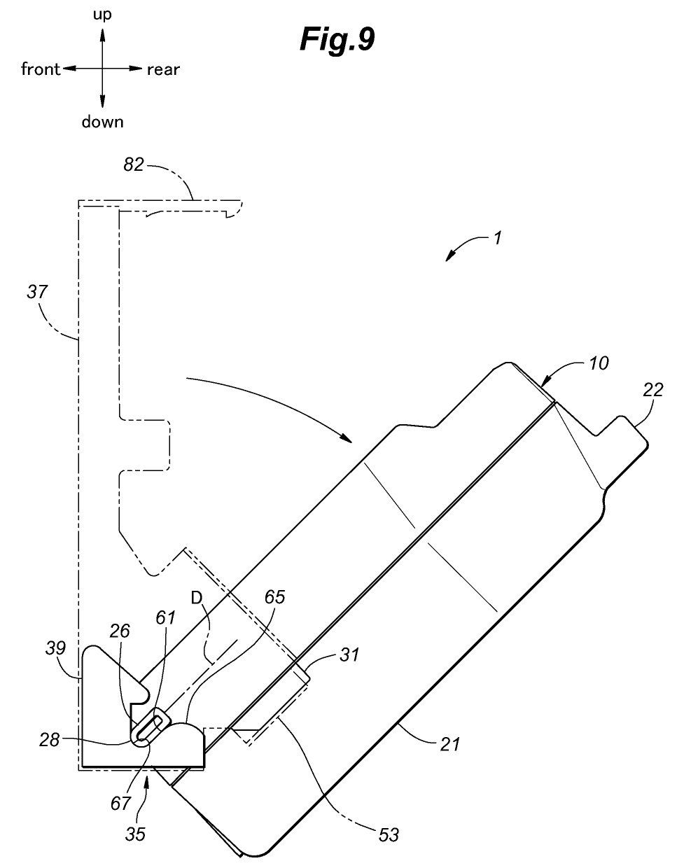

Since the shaft 26 is rotatably received in the receiving recess 61, the battery module 10 is displaceable between the use position shown in FIGS. 4 and 5 and the removal position shown in FIGS. 8 and 9. For example, as shown by arrows in FIGS. 8 and 9, when the worker grasps the grip 22 of the battery module 10 in the use position and tilts the upper portion of the battery module 10 backward, the shaft 26 rolls in the receiving recess 61 and the battery module 10 is displaced to the removal position.

As shown in FIGS. 8 and 9, when the battery module 10 is in the removal position, the rear surface (the side surface on the side opposite from the vehicle body frame 4) of the engagement part 31 contacts the support part 53. Thereby, the engagement part 31 is supported by the support part 53 from the rear surface side (the side opposite from the vehicle body frame 4). Note that when the battery module 10 is in the insertion position, a gap may be formed between the engagement part 31 and the machine body-side curved surface 65.

When the battery module 10 is in the removal position, the worker can remove the battery module 10 from the vehicle body frame 4 by grasping the grip 22 and pulling up the battery module 10 obliquely rearward and upward along the tilt direction D (see FIG. 9).

When mounting the battery module 10, the worker grasps the grip 22 and inserts the lower end of the battery module 10 between the pair of left and right side wall portions 43. Thereafter, the worker inserts the shafts 26 into the corresponding receiving recesses 61 to engage the shafts 26 with the blocks 39. Next, the worker tilts the upper portion of the battery module 10 backward until the rear surface of each engagement part 31 contacts the front surface of the corresponding support part 53, whereby the battery module 10 is brought into the removal position where the battery module 10 is tilted backward (namely, the battery module 10 is tilted in a direction in which the upper portion thereof is separated away from the vehicle body frame 4). Thereafter, when the worker grasps the grip 22 and pushes the upper portion of the battery module 10 forward, the shaft 26 rolls in the receiving recess 61 so that the battery module 10 stands upright and the power feeding connector 33 and the power receiving connector 49 are connected. Thereby, the battery module 10 is placed in the use position.

As described above, since each of the shafts 26 of the battery module 10 is rotatably received in and supported by the corresponding receiving recess 61, the battery module 10 is displaceable between the use position and the removal position where, compared to the use position, the battery module 10 is tilted backward and the battery module 10 can be removed. Due to the shafts 26 and the engagement parts 31 of the battery module 10 and the mounting member 35, the battery module 10 is displaceable between the use position and the removal position, and the holding structure 1 for detachably holding the battery module 10 on the vehicle body frame 4 is configured.

As shown in FIGS. 4 and 5, the holding structure 1 is preferably provided with a lock mechanism 80 for maintaining or locking the battery module 10 in the use position. The lock mechanism 80 preferably includes a locking recess 81 (see also FIG. 8) that is recessed downward in the upper surface of the battery module 10 and a locking member 82 fixed to the mounting member 35 and protruding into the locking recess 81.

Next, effects of the holding structure 1 configured as above will be described. As shown in FIGS. 8 and 9, when the battery module 10 is in the removal position, each of the engagement parts 31 contacts the corresponding support part 53 at the rear surface thereof, and the battery module 10 is supported by the support parts 53 at the rear surfaces of the engagement parts 31. Thereby, when the battery module 10 is in the removal position, the battery module 10 is supported on the vehicle body frame 4 at each of the shafts 26 and the engagement parts 31.

If the engagement parts 31 are not provided, when the battery module 10 is in the removal position, the battery module 10 is supported at the shafts 26. Therefore, the load of the battery module 10 concentrates on the bottom surfaces of the receiving recesses 61. On the other hand, in the present embodiment, since the engagement parts 31 are provided, the battery module 10 is supported on the vehicle body frame 4 at each of the shafts 26 and the engagement parts 31. Therefore, the holding structure 1, the battery module 10, and the vehicle body frame 4 (the machine body) capable of dispersing the load that may be applied from the battery module 10 to the vehicle body frame 4 during installation can be provided. This also contributes to energy efficiency.

Note that the width of each engagement part 31 in the up-down direction is greater than the width of the same in the front-rear direction, and in side view, the engagement part 31 is configured to be elongated in the up-down direction on the left or right side surface of the battery module 10. As a result, the engagement part 31 and the support part 53 can contact each other over a wide range, and the load that may be applied from the battery module 10 to the vehicle body frame 4 can be dispersed more favorably.

Further, the blocks 39are supported by the lower edge parts 55 from below. Therefore, compared to the case where the lower edge parts 55 are not provided, the blocks 39 can be favorably supported when the load is applied from the battery module 10 to the bottom surfaces of the receiving recesses 61.

When the battery module 10 is rotated around the shafts 26 to stand up, the battery module 10 is displaced from the removal position to the use position. It should be noted, however, the male terminal 49A begins to be inserted into the terminal chamber 33A before the battery module 10 completely stands up. The tilt angle of the battery module 10 with respect to the vertical direction when the male terminal 49A begins to be inserted into the terminal chamber 33A becomes greater as the power feeding connector 33 and the shafts 26 are closer.

In the present embodiment, the power feeding connector 33 is provided on the upper portion of the battery module 10. Thereby, compared to a case where the power feeding connector 33 is provided on a lower portion of the battery module 10, the power feeding connector 33 can be disposed at a position more distant from the shafts 26. Therefore, the tilt angle of the battery module 10 with respect to the vertical direction when the male terminal 49A begins to be inserted into the terminal chamber 33A can be made small, and the male terminal 49A can be inserted into the terminal chamber 33A in a more horizontal direction. Accordingly, the power feeding connector 33 can be inserted into the power receiving connector 49 at a more appropriate insertion angle to achieve connection between them.

As shown in FIGS. 5 and 9, the lower edge of the opening of the receiving recess 61 is formed with the machine body-side curved surface 65 which is curved to be convex upward. Thereby, compared to a case where the machine body-side curved surface 65 is not provided, the opening of the receiving recess 61 is widened and the shaft 26 can be inserted into the receiving recess 61 easily.

Further, as shown in FIGS. 5 and 9, the lower edge of the shaft 26 is formed with the shaft-side curved surface 28 which is curved to be convex. Thereby, the shaft 26 is allowed to roll easily on the bottom surface of the receiving recess 61.

The upper edge of each extension part 51 is provided with the diverging part 57 having a flat plate shape. Therefore, when the worker inserts the battery module 10 between the two side wall portions 43, the diverging parts 57 can guide the battery module 10 to a proper position in the left-right direction.

When in the use position, the battery module 10 is supported on the vehicle body frame 4 between the two rear leg parts 13R in the rear view. Therefore, the battery module 10 can be easily attached and detached without being obstructed by the rear leg parts 13R.

Embodiments have been described in the foregoing, but the present invention can be modified in various ways without being limited to the above-described configuration. Also, the concrete structure, arrangement, number, etc. of each member or part may be appropriately changed so long as they do not depart from the spirit of the present invention. Further, parts or whole of the configuration of the above embodiments may be combined with each other. Also, not all of the components shown in the foregoing embodiments are necessarily indispensable and they may be selectively adopted as appropriate.

In the above embodiment, description was made of an example in which the holding structure 1 was applied to the inverted pendulum vehicle, but the holding structure 1 may be applied to any other device (for example, an electric bicycle, a robot, or the like) that is driven by the battery.

In the above embodiment, description was made of an example in which the holding structure 1 was provided in the rear portion of the electric vehicle 2, but the holding structure 1 may be provided in the front portion, left side portion, or right side portion of the electric vehicle 2.

Lastly, the above embodiment may be summarized as follows.

One embodiment is a holding structure 1 for detachably hold a battery module 10 on a machine body (the vehicle body frame 4), the holding structure 1 comprising: at least one shaft 26 provided on a lower portion of the battery module 10; and at least one receiving recess 61 provided in the machine body and opening in a tilt direction D which is tilted outward of the machine body toward an upper side, wherein each of the at least one shaft 26 is rotatably received in a corresponding one of the at least one receiving recess 61 such that the battery module 10 is displaceable between a use position and a removal position where, compared to the use position, the battery module 10 is tilted in a direction in which an upper portion thereof is separated away from the machine body and where the battery module 10 can be removed along the tilt direction D, the battery module 10 includes at least one engagement part 31 provided above the at least one shaft 26, and the machine body is provided with at least one support part 53 that supports a side surface of the at least one engagement part 31 on a side opposite from the machine body when the battery module 10 is in the removal position.

According to this aspect, when the battery module 10 is in the removal position, the battery module 10 is supported by the support part 53 at the side surface of the engagement part 31 on the side opposite from the machine body. Therefore, when the battery module 10 is in the removal position, the battery module 10 is supported at the engagement part 31 in addition to the shaft 26, whereby the holding structure 1 capable of dispersing the load that may be applied from the battery module 10 to the machine body during installation can be provided.

In the above aspect, preferably, the at least one shaft 26 comprises a pair of left and right shafts 26 and the at least one engagement part 31 comprises a pair of left and right engagement parts 31.

According to this aspect, the battery module 10 in the removal position can be stably supported on the machine body.

In the above aspect, preferably, the at least one engagement part 31 protrudes from a side surface of the battery module 10 and extends in an up-down direction.

According to this aspect, the load that may be applied from the battery module 10 to the vehicle body frame 4 can be dispersed more favorably.

In the above aspect, preferably, the battery module 10 is provided with a power feeding connector 33 for feeding power to the machine body, the machine body includes a power receiving connector 49 that is connected to the power feeding connector 33 when the battery module 10 is in the use position, and the power feeding connector 33 is provided on an upper portion of the battery module 10.

According to this aspect, since the power feeding connector 33 is disposed at a position distant from the shaft 26, the power feeding connector 33 can be connected to the power receiving connector 49 at a more appropriate insertion angle.

In the above aspect, preferably, each of the at least one receiving recess 61 is provided with a restricting part 71 that is positioned on an upper side of a corresponding one of the at least one shaft 26 and restricts an upward movement of the corresponding one of the at least one shaft 26 when the battery module 10 is in the use position.

According to this aspect, when in the use position, an upward movement of the battery module 10 can be restricted.

In the above aspect, preferably, a lower surface of the restricting part 71 is provided with a restriction surface 73 that faces downward and is flat.

According to this aspect, when in the use position, an upward movement of the battery module 10 can be favorably restricted.

In the above aspect, preferably, a lower edge of an opening of the at least one receiving recess 61 is formed with a machine body-side curved surface 65 that is curved to be convex upward.

According to this aspect, the insertion of the shaft 26 into the receiving recess 61 becomes easy and the mounting of the battery module 10 to the machine body becomes easy.

In the above aspect, preferably, a lower edge of the at least one shaft 26 is formed with a shaft-side curved surface 28 that is curved to be convex.

According to this aspect, the battery module 10 is allowed to rotate easily.

One embodiment is a battery module 10 configured to be supported on a machine body to be displaceable between a use position and a removal position where, compared to the use position, the battery module 10 is tilted in a direction in which an upper portion thereof is separated away from the machine body and where the battery module 10 can be removed, the battery module 10 comprising: a main body (the module main body 21); a shaft 26 provided on a lower portion of the main body to be rotatably supported by the machine body; and an engagement part 31 provided above the shaft of the main body and supported on the machine body in the removal position.

According to this aspect, since the engagement part 31 is supported by the machine body, the battery module 10 capable of dispersing the load that may be applied from the battery module 10 to the machine body during installation can be provided.

One embodiment is a machine body configured to support a battery module 10 to be displaceable between a use position and a removal position where, compared to the use position, the battery module 10 is tilted in a direction in which an upper portion thereof is separated away from the machine body and the battery module 10 can be removed, by rotatably supporting a shaft 26 of the battery module 10, wherein the machine body is provided with a support part 53 that supports the battery module 10 when the battery module 10 is in the removal position.

According to this aspect, when in the removal position, the battery module 10 can be supported by the support part 53, and thus, the machine body capable of dispersing the load that may be applied from the battery module 10 to the machine body during installation can be provided.

1. A holding structure for detachably holding a battery module on a machine body, the holding structure comprising:
at least one shaft provided on a lower portion of the battery module; and
at least one receiving recess provided in the machine body and opening in a tilt direction which is tilted outward of the machine body toward an upper side,
wherein each of the at least one shaft is rotatably received in a corresponding one of the at least one receiving recess such that the battery module is displaceable between a use position and a removal position where, compared to the use position, the battery module is tilted in a direction in which an upper portion thereof is separated away from the machine body and where the battery module can be removed along the tilt direction,
the battery module includes at least one engagement part provided above the at least one shaft, and
the machine body is provided with at least one support part that supports a side surface of the at least one engagement part on a side opposite from the machine body when the battery module is in the removal position.

2. The holding structure according to claim 1, wherein the at least one shaft comprises a pair of left and right shafts and the at least one engagement part comprises a pair of left and right engagement parts.

3. The holding structure according to claim 1, wherein the at least one engagement part protrudes from a side surface of the battery module and extends in an up-down direction.

4. The holding structure according to claim 1, wherein the battery module is provided with a power feeding connector for feeding power to the machine body,
the machine body includes a power receiving connector that is connected to the power feeding connector when the battery module is in the use position, and
the power feeding connector is provided on an upper portion of the battery module.

5. The holding structure according to claim 1, wherein each of the at least one receiving recess is provided with a restricting part that is positioned on an upper side of a corresponding one of the at least one shaft and restricts an upward movement of the corresponding one of the at least one shaft when the battery module is in the use position.

6. The holding structure according to claim 5, wherein a lower surface of the restricting part is provided with a restriction surface that faces downward and is flat.

7. The holding structure according to claim 1, wherein a lower edge of an opening of the at least one receiving recess is formed with a machine body-side curved surface that is curved to be convex upward.

8. The holding structure according to claim 1, wherein a lower edge of the at least one shaft is formed with a shaft-side curved surface that is curved to be convex.

9. A battery module configured to be supported on a machine body to be displaceable between a use position and a removal position where, compared to the use position, the battery module is tilted in a direction in which an upper portion thereof is separated away from the machine body and where the battery module can be removed,
the battery module comprising:
a main body;
a shaft provided on a lower portion of the main body to be rotatably supported by the machine body; and
an engagement part provided above the shaft of the main body and supported on the machine body in the removal position.

10. A machine body configured to support a battery module to be displaceable between a use position and a removal position where, compared to the use position, the battery module is tilted in a direction in which an upper portion thereof is separated away from the machine body and where the battery module can be removed, by rotatably supporting a shaft of the battery module,
wherein the machine body is provided with a support part that supports the battery module when the battery module is in the removal position.
